(19) United States
(12) Patent Application Publication
(10) Pub. No.: US 2004/0177072 A1
(43) Pub. Date: Sep. 9, 2004

(54) Smart environment

(76) Inventors: Ilkka Salminen, Tampere (FI); Hannu Nieminen, Lempaala (FI); Timo Tuomisto, Nokia (FI); Atte Kinnula, Kempele (FI)

Correspondence Address: BANNER & WITCOFF, 1001 G STREET N W, SUITE 1100, WASHINGTON, DC, 20001, US

(21) Appl. No.: 10/477,611

(22) PCT Filed: May 17, 2001
(86) PCT No.: PCT/US01/15954

(51) Int. Cl. G06F 17/30

(52) U.S. Cl. 707/9

(57) ABSTRACT

A method and system for providing selective access to appliances by terminals in a smart environment is provided. Each terminal and appliance is assigned a unique identification code (UID). Appliances and terminals wireless transmit their UID and receive UIDs transmitted by other appliances and terminals. Upon receiving a terminal's UID, an appliance queries a database to determine whether the terminal is authorized to control that appliance based on authorization information stored in the database. An owner may be notified id a terminal without authorization attempts to control an appliance or enters the environment.

### BACKGROUND OF THE INVENTION

The present invention relates generally to security. More particularly, the invention relates to a wireless lock and key system used to selectively prevent individuals from operating appliances when a predetermined set of criteria are met.

When access to an item, appliance, tool, or the like is to be restricted, generally a physical lock has been used. Locking the restricted item in a room behind a locked door is another known means to restrict access to an item or area. Conventional types of physical locks include combination locks and key locks, both commercially available on a widespread basis.

Combinations locks are well known. Combination locks open only when a user has entered the correct combination code, usually a sequence of numbers. However, combination locks have many shortcomings. Many combination locks have the combination set at the factory, and the combination cannot be changed by the purchaser of the lock. In addition, once a person is given the combination, it cannot be taken away. Thus the only way to restrict access to an individual who knows the combination is to physically change the lock, which requires redistributing the new combination to each of the other prior users of the lock other than the restricted individual. Also, because a person can communicate the correct combination an unlimited number of times, there is potentially an unlimited number of persons who might know the correct combination. Once an individual has received the combination, there are no means by which that individual can physically be restricted from communicating the combination to additional individuals. Combination locks also can't notify the owner if used without authorization.

Key locks are also known in the art. Key locks open only when the correct physical key is inserted into the lock and turned, thus opening the locking mechanism. Key locks, however, also have several disadvantages. Physical keys are easily copied, potentially allowing unwanted copies to be created and given to unauthorized individuals. Additionally, if all physical keys for a given lock are lost, a locksmith must be hired to create a replacement key, often at great cost to the lock owner. As with combination locks, the owner of the lock is generally not notified if the lock is opened by a user without authorization.

There is a common problem to both key and combination locks in that access is either all or nothing. That is, an individual either has access to the lock (i.e., has the key or knows the combination) or they do not. Also, there is no way to differentiate access between users. All users who have access have the same access. There is no way, using only one lock and key, to provide certain access privileges to a first user and other access privileges to a second user.

When an individual wants to restrict access to an appliance, such as a cable control box or controls on a television, conventional physical locks have generally been used by constructing a physical barrier over the controls, with access restricted by a lock. More recently, electronic parental control devices have been developed. These systems generally allow a user, using a handheld remote control device, to input a first code key that allows programs which meet a first set of predetermined criteria to be watched, and to input a second code key to allow programs which meet a second set of predetermined criteria to be watched. In this manner, children can be restricted from watching programs deemed not suitable by parents. However, this solution is only applicable to televisions and cable set top boxes. A parent cannot use these systems to restrict access to other appliances in the household.

Another known means of restricting access to appliances, again with respect to televisions, is the use of the V-chip, which is well known in the art. The V-chip, however, only restricts access to a television, and not to additional appliances such as computers, ovens, stoves, lights, and the like.

Access to computers has been restricted using specialized software installed on the computer system. However, these software packages also only restrict use of the computer system, and not of other appliances.

A lock and key system is needed that restricts access to multiple appliances while providing ease of adaptability by providing differing access levels to different users. A system is needed that allows an owner to give other people such as family members, houseguests, etc., differing rights to use different appliances, gives the owner a method to control who can use appliances and when they can use them, and gives the owner immediate notification if an appliance is used against his or her authority.

### SUMMARY OF THE INVENTION

In a first aspect of the invention, a smart environment allows terminals to selectively control appliances. There is a plurality of appliances, where each appliance is assigned a unique identifier (UID). There is a plurality of terminals, where each terminal is also assigned a unique identifier. There is also a database of authorization information, with information corresponding to which terminals and when terminals can control appliances. Each appliance, prior to allowing control by one of the terminals, queries the authorization information to verify that the terminal is authorized to control that appliance.

In a second aspect of the invention, there is a method for allowing one or more terminals to selectively control one or more appliances in a smart environment Each terminal and each appliance has a UID. One of the terminals wirelessly transmits its UID to one of the appliances. The appliance queries an authorization database for the received UID. The appliance grants control to the terminal when the database contains predetermined authorization information corresponding to the terminal UID. The terminal may then wirelessly control the appliance.

In a third aspect of the invention, there is a wireless terminal that has a transceiver that communicates with an appliance. The wireless transceiver repetitively transmits its unique identifier (UID), and listens for an appliance UID transmitted by the appliance. The terminal also has a memory for storing computer data. The computer data includes the terminal's unique identifier (UID), an appliance database that stores information corresponding to controlling the appliance, and computer readable instructions that, when executed, cause the terminal to perform the step of querying the appliance database for information corresponding to the received appliance UID.

In a fourth aspect of the invention, there is a computer readable medium comprising computer readable instructions that, when executed in an appliance cause it to perform a set of steps. The appliance transmits an appliance unique identifier (UID), and receives a terminal UID. The appliance queries an authorization database for authorization information corresponding to the terminal UID. The appliance selectively grants access to the appliance by a terminal corresponding to the received terminal UID based on the authorization information returned from the query.

In a fifth aspect of the invention, there is an appliance that has a wireless transceiver that communicates with at least one terminal. The wireless transceiver repetitively transmits a unique identifier (UID) associated with the appliance, and listens for a terminal UID transmitted by a terminal. The appliance also has a memory for storing computer data. The computer data includes the unique identifier (UID) associated with the appliance, and computer readable instructions that, when executed, cause the appliance to perform a set of steps. The appliance queries an authorization database for information corresponding to the received terminal UID. The appliance allows the terminal associated with the received terminal UID to control the appliance when the query results meet predetermined criteria.

### BRIEF DESCRIPTION OF DRAWINGS

FIG. 1 shows a smart environment.

FIG. 2A shows a block diagram of a server.

FIG. 2B shows a block diagram of a terminal.

FIG. 2C shows a block diagram of an appliance.

FIG. 3A shows Unique Identifier (UID) Information.

FIG. 3B shows a portion of Access Rights Information for the UIDs of FIG. 3A.

FIG. 3C shows Neighbor UID Information for the UIDs of FIG. 3A.

FIG. 4 shows a flowchart of a user authorization process to use an appliance.

### DETAILED DESCRIPTION OF PREFERRED EMBODIMENTS

Wireless connections between devices are becoming more and more widespread. The present invention uses wirelessly connected devices to create a smart environment, e.g. homes where the various household appliances are controlled remotely by one or more controlling terminals. The terminals communicate with and control appliances using a wireless technology such as Bluetooth, wireless LAN, or Home RF. Any wireless communication technology can be used.

The invention may be embodied in a system that allows the owner of an environment to control and monitor who is using and when each person can use each appliance. The inventive system may also notify the owner whenever someone who does not have rights to use the appliances within the environment attempts to use one or more of the appliances, or optionally when a user without access rights enters the environment. The notification may be sent by a short message service (SMS), email, direct network access, instant message, alphanumeric pager, WAP (wireless application protocol) service, or the like.

In a smart environment, an environment owner is often concerned that the environment can only be controlled by those that are trusted and have been given authority by the owner. The “owner” of the environment is a person that has administrative rights to the environment. This may be the actual owner or anybody he or she has authorized to act as an administrator. The owner(s) can limit the access rights and times of each user to each appliance.

Throughout this specification, the term “appliance” is used to refer to any item controlled or operated by a user, generally using a terminal (but not required, as discussed below). Examples of appliances include, but are not limited to, televisions, video cassette-recorders and players, DVD players, conventional ovens, microwave ovens, kitchen appliances, lighting systems, heating systems, air conditioning systems, garage door openers, lawn sprinkler systems, stereo equipment, cable television boxes, video game consoles, computers, and the like. A user using a controller terminal can control each appliance for which the user has the proper access rights. Throughout this specification, the terms “controller” and “terminal” are used interchangeably to describe a wireless-enabled device that is used to operate or control appliances. The terminal may be a computer system, palm-top computer, personal digital assistant, mobile phone, or any other device with wireless communication capabilities.

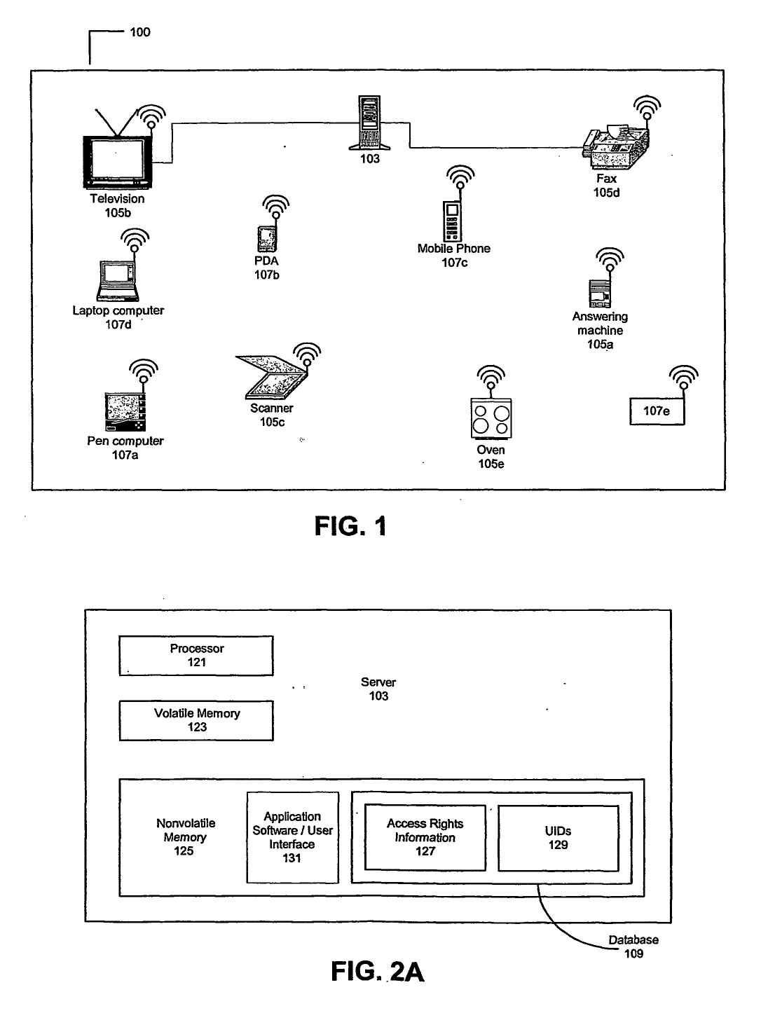

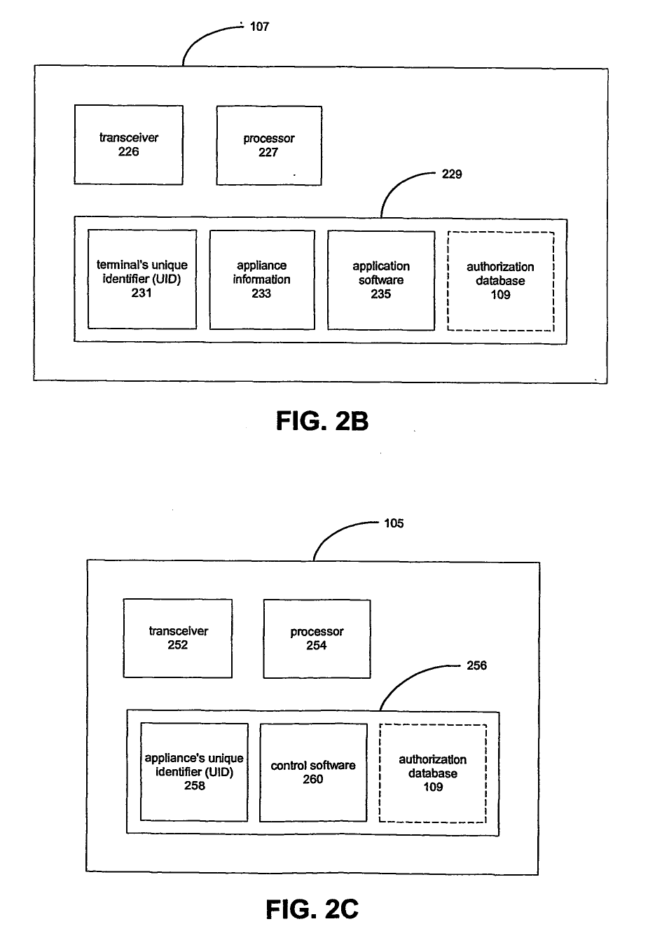

With reference to FIGS. 1-3, a smart environment 100 may comprise a central server 103, appliances 105a-105e, and wireless controller terminals 107a-107e. Additional appliances and terminals may easily be added. The number of terminals or appliances in an environment is limited only by physical space. Appliances may communicate with server 103 using the wireless communication technology used throughout the environment, or via conventional network cabling. Unless terminals are docked in a docking station (not shown) connected to the server, terminals generally communicate with the server via wireless communications.

The server 103 is comprised of a processor 121, volatile memory 123, and nonvolatile memory 125. A database 109 is stored within the nonvolatile memory of server 103. In another variation, a third party provides the server functions, including storage of the database 109, over a network such as the Internet. It is further possible that the database is stored in one or more mobile terminal(s). A terminal in which the database is stored is referred to herein as a database terminal. When the database is stored in a mobile terminal, the other appliances and terminals generally must have a connection to the terminal in which the database is stored. The connection may be by any communication means, such as WLAN, Bluetooth, GSM via short message service (SMS), or the like. Storing the database in a terminal provides additional security because, if the terminal is removed from the environment, the appliances may become useless.

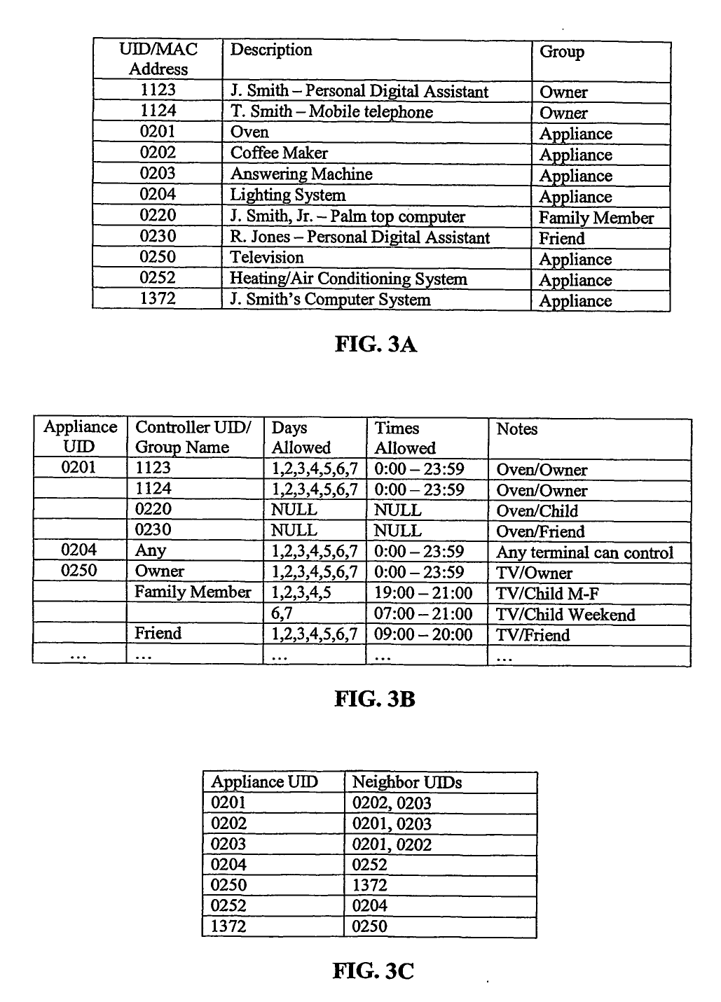

Authorization information is stored in the database and comprises unique identifier (UID) information 129 and access rights information 127, as described below. Optionally (shown in FIG. 3C), neighbor UID information may be included in the database as well. Application software 131, including an optional user interface for modifying access rights information and UID information, may also be stored in non-volatile memory 125.

Each terminal 107 has a wireless transceiver 226, a processor 227, and a memory 229. The transceiver is used for sending and receiving information such as UIDs and control information. The processor 227 is used for executing computer readable instructions 235 stored in memory 229. The memory also stores the terminal's UID 231, appliance information 233, and optionally, authorization database 109.

Each appliance 105 has a wireless transceiver 252, a processor 254, and a memory 256. The transceiver is used for sending and receiving information such as UIDs and control information. The processor 254 is used for executing computer readable instructions 260 stored in memory 256. The memory also stores the appliance's UID 258 and, optionally, authorization database 109.

Each wireless terminal and appliance is assigned a unique identification code (UID), which may comprise the Media Access Control (MAC) address for each wirelessly networked device. The UIDs are stored in database 109, optionally along with each UID's group access level (e.g., owner, administrator, family member, friend, employee, visitor, etc.). A UID information table is shown in FIG. 3A. In FIG. 3A, the terminals with UIDs 1123 and 1124 are owner terminals. The terminal with UID 0220 belongs to a child J. Smith, Jr. in the group “Family Member,” and the terminal with UID 0230 belongs to R. Jones in the group “Friend.” Other UIDs belonging to appliances are also shown.

The UIDs of any terminal and appliance may be automatically exchanged according to network protocols when they are within wireless communication range. The appliance may use the UID for a query of database 103 in order to determine whether the terminal has rights to command that appliance. The terminal may use the UID to load information regarding how to control the appliance being accessed by the terminal.

Appliances generally have a second user interface, in addition to the terminal interface, so they can be controlled physically as well as through the terminals. For example, a coffee machine may include an on/off switch so that a user may just flip the switch to turn the coffee machine on when no terminal is present. In some aspects of the invention, physical controls are disabled when it is determined that a user's terminal does not have authority to access the appliance, or when no terminal is present.

Each appliance may be associated with access rights for specified terminals. The access rights information 127 is stored in database 109, and may be modified via a user interface with the database over a computer network, such as the Internet. A sample access rights information table is shown in FIG. 3B. The owner may provide differing access rights for different appliances and/or terminals under different sets of predetermined criteria Access rights may be terminal based, time based, or both. Terminal based access rights are rights wherein specified terminals can always access the appliance, and other terminals can never access the appliance. Time based access rights are rights wherein terminals may only access the appliance during predetermined times, and at all other times are restricted from accessing or controlling the appliance. Terminal and time based access rights are rights wherein each terminal is provided a predetermined range of time that it may access or control a specified appliance.

For example, as shown in FIG. 3B, in a smart environment within a home, one user's (owner terminal with UID 1123) terminal may have access rights to the television and oven at all times. However, a second user's (Family terminal with UID 0220, for instance, a child) terminal may have access rights to the television only from 7:00 pm-9:00 pm on Monday through Friday and from 7:00 am-9:00 pm on weekends, and have no access to the oven. A third user's (Friend terminal with UID 0230, for instance, a babysitter) terminal might have access to the television only from 9:00 am-8:00 pm regardless of the day of the week, and have no access to the oven. As shown in FIG. 3B, access rights may be terminal-specific or group-specific. For instance, any terminal in the Owner, Family Member, or Friend group will have the same access to the television as every other terminal in their respective group. However, each terminal is given specific access to the oven. Thus, one family member (for instance, an older child, not shown) may have access to the oven while a second family member (a younger child, shown) may not have any access to the oven. It is also possible to further base access rights by week, month, etc, such that access rights could vary by weeks of the month, months of the year, etc.

It is also possible that some appliances may be set to have no access restrictions, but rather the only requirement is that a terminal be present for the appliance to be used or controlled. For instance, as shown in FIG. 3B, an owner may give all users the right to switch the lights on or off. In these cases there is no need to determine whether the terminal has authorization, or even if it is known. It is enough that the terminal is in the environment, and so it will have the right to switch the lights on or off. Optionally, the appliance may query the database to determine whether the terminal at least has access rights within the environment before allowing the user to control the appliance.

When an appliance is added to an environment, the appliance is branded to that environment. That is, the appliance records the identity of its environment so that it can differentiate its own environment from other environments. This allows the appliance to determine whether it is has been moved to a different environment. The identity of the environment may be established by recording UIDs transmitted by appliances near the new appliance (neighbor appliances). For example, appliance 105e (oven) knows that it is near appliances 105a (answering machine) and 105c (scanner). Each appliance may store its own neighbor information into a flash-memory, which can only be cleared by a terminal with authority to so (owner terminal or special maintenance device). The neighbor UID information may also be stored collectively in database 109, a sample of which is shown in FIG. 3C.

After branding, only an owner can move the appliance out of the environment, or the appliance may not function. Optionally, even within the environment the appliance cannot be moved, except by the owner. The appliance may determine that it has been removed from its environment by determining that different neighbor appliances are surrounding it. In observing its wireless surroundings, an appliance may infer that it has been stolen if the surroundings dramatically change (e.g., more than two different neighbor appliances are detected than expected). If an appliance is stolen or otherwise taken from its own environment, it may optionally lock itself and refuse to operate until unlocked. In that event, generally an owner key may be required to unlock the appliance. The appliance may also attempt to contact its owner (not the owner of the environment in which it is now located) in order to notify the owner that it has been removed from its environment.

In an embodiment using a database terminal, a secure link between the database terminal and the appliance is created when adding a new appliance to the environment. This allows the appliance to securely determine whether the controlling terminal has rights, i.e., that the controlling terminal is a trusted database terminal. Putting the database terminal and the appliance physically close to each creates the secure link. The appliance and the database terminal exchange their public keys or other encryption data. Thereafter the appliance and terminal will listen and communicate only to each other, such that the appliance can be safely added to the environment.

In network topographies where the database is stored in a central server or in another location, a mobile terminal, e.g., an owner terminal, and the newly added appliance are similarly branded as when the database is stored in the mobile terminal. That is, the owner terminal and the appliance establish a secure link as in the above example. The terminal, however, also establishes a secure link with the database. The secure link may be created by putting the terminal and the server physically close to each other. That is, a mobile terminal establishes a secure link with a newly added appliance, and the same mobile terminal also establishes a secure link with the database server. In such a scenario the branding of the appliance to the environment is a two-step procedure, where the terminal, as a trusted introducer, is used by the server and the appliance to establish a secure link. First, the terminal exchanges public keys with the appliance, and also exchanges the public key of the database with the appliance. The terminal then is brought near the database, and exchanges public keys with the database, as well as the public key of the appliance with the database. After this exchange, the appliance will not trust another terminal as an introducer unless the appliance is reset via a maintenance procedure.

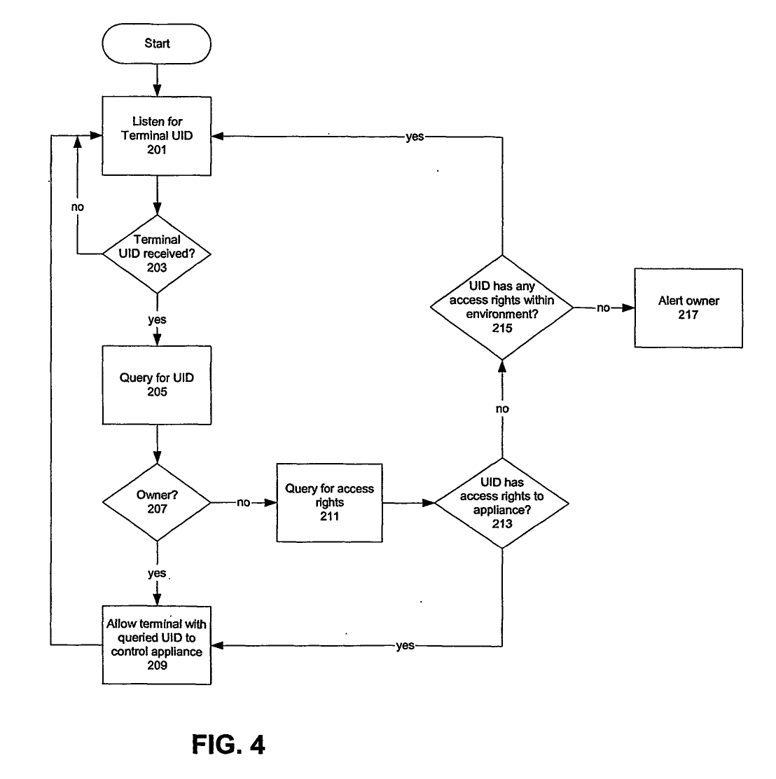

With reference to FIG. 4, when a user wants to control an appliance, the appliance authenticates the terminal as an authorized terminal to control that appliance. The UID of the controller terminal is used as a key to the appliance. Appliances continuously listen for terminal UIDs in steps 201 and 203. Upon receiving a UID, the appliance queries the database 109 in step 205 to determine the UID's group. If the UID belongs to an owner terminal, as determined in step 207, the appliance grants control to the terminal in step 209, as owner terminal(s) have complete access to all appliances at all times. If the UID is not an owner, the appliance queries the database for the UID's access rights for that specific appliance and within the environment as a whole, in step 211. If the UID has access rights to the appliance at the present date and time, the appliance grants control to the terminal in step 209. If the UID does not have access rights, the appliance determines whether the terminal has any access rights within the environment, in step 215. If the terminal does not have any access rights within the environment, the appliance attempts to alert the owner that an unauthorized terminal is in the environment, in step 217. This may be accomplished by sending a message via email, SMS, wireless pager, or the like. If the UID does have access rights within the environment, however, the appliance may simply ignore the terminal and continue to listen for another UID. Optionally (not shown), the server may perform steps 215 and 217 after it has received the UID from the appliance in step 205.

In one embodiment, an owner terminal may be used to grant or change other terminals' access rights. These other terminals can have different levels of access, as discussed above. To authorize a new terminal, both a terminal with administrative privileges (i.e., an owner) and the terminal to which the access rights are to be given are in close proximity to each other when the database is updated. This provides an additional level of security by ensuring that only authorized persons can give access rights to terminals. The UID codes between the terminals are exchanged over a short-range link. Additional security measures such as passwords can also be utilized in the authorization process. In another embodiment, the terminals do not need to be physically close to each other, but rather the database can be updated with the new information.

In some aspects of the invention, regardless of the wireless implementation, the terminals and appliances continuously transmit their UIDs and listen for other UIDs. This allows the terminals and appliances to automatically “hear” each other when they are near each other. The UIDs allow listening devices to determine whether it has previous knowledge about the other nearby device(s), and react accordingly. For instance, when a terminal receives a UID, the terminal uses the UID to determine whether the terminal has information regarding how to control the appliance.

The central server in the smart environment polls the appliances. This can be performed continuously, hourly, daily, etc. When the server determines that an appliance is missing from the network (i.e. it is not responding when it should be), the server may automatically notify the owner controller or, optionally, all controllers.

Using the invention, keys (UIDs) can easily be revoked or modified by reprogramming or resetting the information in the terminal and/or database. Also, keys may easily be set to have different access levels, as described above. The key may be a built in function in existing terminals, such that new wireless hardware is not required to practice the invention. However, one can easily envision a specialized terminal for use with the invention that, at a minimum, stores key information and can perform short-range wireless communications.

An owner or administrator can also use the system of the present invention as a child lock for selected appliances. For example, the system may be used to prevent a child from turning on an oven (or other appliance) without explicit permission from the parent. That is, if the child tries to turn on the oven, the oven would not respond because it would only hear the child's key (which, in this example, does not have authority to use the oven). However, if the parent enters the kitchen and the oven detects the parent by receiving the parent's key, the oven could then be turned on (because the parent's key has authority to use the oven). In one aspect of the invention, the oven (or other appliance) would switch off once the authorized key went out of range unless an authorization switch was activated on the oven (or other appliance for which protection is sought) while it was under the parent's authorization. Similar protection schemes can easily be envisioned using the inventive system. In another aspect, the oven (or other appliance) would remain on even after the authorized key went out of range.

In one aspect of the invention, the appliances report information to the database regarding when the appliance was used, by whom the appliance was used, and for what purpose the appliance was used. Some appliances, for example a coffee maker, may only report when and who used the appliance (as the only purpose is to make coffee). However, other appliances, such as televisions, cable television control boxes, computers, and the like, may also report programs watched, games played, applications executed, websites visited, and the like. This allows owners (such as parents) to determine how the appliances are used, and refine access rights based on the reporting information.

Wherever the above description refers to method steps, the method steps may be encoded in computer readable instructions stored in a memory, such that when the computer readable instructions are executed by a processor, they cause the device in which the processor is located to perform the method steps.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

What is claimed is:

1. A smart environment for providing selective access to appliances comprising:
a plurality of appliances, wherein each appliance is assigned a unique identifier (UID);
a plurality of terminals adapted to wirelessly communicate with and control the appliances, wherein each terminal is assigned a UID; and
a database adapted to store authorization information;
wherein each appliance, prior to allowing control by one of the terminals, queries the authorization information to verify that the one terminal is authorized to control that appliance.

2. The smart environment of claim 1, wherein the database is stored in a server computer.

3. The smart environment of claim 1, wherein the database is stored in one of the terminals.

4. The smart environment of claim 1, wherein the database is stored in one of the appliances.

5. The smart environment of claim 1, wherein appliances and terminals are adapted to transit their assigned UID.

6. The smart environment of claim 1, wherein an appliance sends a warning notification when the appliance queries the database for a UID that meets a predetermined condition.

7. The smart environment of claim 1, wherein a terminal sends a warning notification when the appliance queries the database for a UID that meets a predetermined condition.

8. The smart environment of claim 2, wherein the server sends a warning notification when the appliance queries the database for a UID that meets a predetermined condition.

9. The smart environment of claim 8, wherein the predetermined condition is the terminal does not have access rights to control any appliance at any time.

10. The smart environment of claim 1, wherein a first terminal's authorization information corresponds to a first set of access rights, and a second terminal's authorization information corresponds to a second set of access rights that are different from the first set of access rights.

11. The smart environment of claim 10, wherein the first set of access rights comprises always being able to access an appliance, and the second set of access rights corresponds to never being able to access an appliance.

12. The smart environment of claim 1, wherein a first terminal is granted control over an appliance during a first predetermined time period.

13. The smart environment of claim 12, wherein a second terminal is granted control over the appliance during a second predetermined time period, different from said first predetermined time period.

14. The smart environment of claim 1, wherein the UID is a network address used to wirelessly communicate.

15. A method for providing selective access to one or more appliances by one or more terminals in a smart environment, where each terminal and each appliance have a unique identifier (UID), comprising the steps of:
(i) wirelessly transmitting a UID from one of the terminals to one of the appliances;
(ii) querying a database of authorization information for the received UID;
(iii) granting control of the one appliance to the terminal when the database contains predetermined authorization information corresponding to the terminal; and
(iv) using the one terminal to control the one appliance.

16. The method of claim 15, wherein the database is stored in a server computer.

17. The method of claim 15, wherein the database is stored in one of the terminals.

18. The method of claim 15, wherein the database is stored in one of the appliances.

19. The method of claim 15, comprising the step of:
(v) sending a notification to a predetermined location when the query of step (ii) determines that the terminal's UID meets a predetermined condition.

20. The method of claim 19, wherein the predetermined condition is the one terminal does not have access rights to control any appliance at any time within the smart environment.

21. The method of claim 15, wherein a first terminal's authorization information corresponds to a first set of access rights, and a second terminal's authorization information corresponds to a second set of access rights.

22. The method of claim 15, wherein a first terminal is granted control over an appliance during a first predetermined time period.

23. The method of claim 22, wherein a second terminal is granted control over the appliance during a second predetermined time period, different from the first predetermined time period.

24. A wireless terminal, comprising:
a wireless transceiver that communicates with at least one appliance, wherein the wireless transceiver repetitively transmits a unique identifier (UID), and listens for an appliance UID transmitted by an appliance, and
a memory for storing data comprising:
a terminal unique identification (UTn),
an appliance database comprising information corresponding to controlling at least one appliance; and
computer readable instructions that, when executed, cause the terminal to perform the step of querying the appliance database for information corresponding to a received appliance UID.

25. The wireless terminal of claim 24, wherein the wireless transceiver communicates using radio communications.

26. The wireless terminal of claim 24, wherein the data stored in the memory further comprises an authorization database, and wherein the computer readable instructions further cause the terminal to perform the steps of:
(ii) receiving an authorization request from an appliance;
(iii) querying the authorization database based on the authorization request; and
(iv) sending a query result to the appliance.

27. A computer readable medium comprising computer readable instructions that, when executed in an appliance cause it to perform the steps of:
(i) transmitting an appliance unique identifier (UID);
(ii) receiving a terminal UID;
(iii) querying an authorization database for authorization information corresponding to the terminal UID; and
(iv) selectively granting access to the appliance by a terminal corresponding to the received terminal UID based on the authorization information returned in step (iii).

28. The computer readable medium of claim 27, wherein the computer readable instructions further perform the step of sending a notification when the query of step (iii) returns information meeting predetermined criteria.

29. The computer readable medium of claim 28, wherein the criteria is that the returned information represents that the terminal does not have access rights to any known appliance.

30. An appliance, comprising:
a wireless transceiver that communicates with at least one terminal, wherein the wireless transceiver repetitively transmits a unique identifier (UID) associated with the appliance, and listens for a terminal UID transmitted by a terminal, and
a memory for storing data comprising:
the unique identifier (UID) associated with the appliance,
computer readable instructions that, when executed, cause the appliance to perform the steps of:
(i) querying an authorization database for information corresponding to a received terminal UID; and
(ii) allowing the terminal associated with the received terminal UID to control the appliance when the query results from step (i) meet predetermined criteria.

31. The appliance of claim 30, wherein the transceiver communicates using radio communications.

32. The appliance of claim 30, wherein the authorization database is stored in the memory.

33. The appliance of claim 30, wherein the transceiver listens for appliance UIDs transmitted by other appliances, and wherein the computer readable instructions further cause the appliance to perform the steps of:
(iii) during a predetermined time period, recording a first set of received appliance UIDs; and
(iv) during any time other than the predetermined time period, comparing a second set of received appliance UIDs to the first set of appliance UIDs.

34. The appliance of claim 30, wherein the computer readable instructions further cause the appliance to perform the step of, when the number of differing UIDs between the first set and the second set meets predetermined criteria, sending a warning notification to a predetermined location.

35. The appliance of claim 30, wherein the computer readable instructions further cause the appliance to perform the step of, when the number of differing UIDs between the first set and the second set meets predetermined criteria, performing a predetermined action.

36. The appliance of claim 35, wherein the predetermined action is turning the appliance off.

37. The appliance of claim 35, wherein the predetermined action is not granting control to a terminal that would otherwise be granted control of the appliance.

38. The appliance of claim 35, wherein the predetermined action is locking the appliance so that no terminal can control it until an owner terminal unlocks the appliance.
